(19) United States
(12) Patent Application Publication
(10) Pub. No.: US 2007/0017402 A1
(43) Pub. Date: Jan. 25, 2007

(54) Vitreous printing by means of a silkscreen process

(75) Inventors: Frank Jordens, TRAUNSTEIN (DE); Axel Kalleder, Blieskastel (DE); Gerhard Schmidmayer, Bad Endorf (DE); Detlev V. Loschner, Palling (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, MUNICH (DE)

(21) Appl. No.: 10/550,219

(22) PCT Filed: Mar. 23, 2004
(86) PCT No.: PCT/EP04/03079

§ 371 Date: May 19, 2006

(30) Foreign Application Priority Data
Mar. 26, 2003 (DE) 10313630.4

(51) Int. Cl. B41F 31/00

(52) U.S. Cl. 101/491

(57) ABSTRACT

A enamel-free paste for use especially in ovens at temperatures of up to about 420° C. The paste contains a matrix based upon a silicon (Si) polymer that can be obtained by the hydrolysis and condensation of at least one silane of general formula RₓSi(OR′)₄₋ₓ with at least one polysiloxane of general formula [R₂SiO]_{y}, or R₃Si—(O—SiR₂)_{y}—O—SiR₃. The radicals R can independently be alkyl, aryl,arylalkyl, alkylaryl or H; the radicals R′ can independently be H, methyl,ethyl, n- or i-propyl, n-, iso-, sec- or tert-butyl; x represents 0 or 1 (for the first silane); x represents 0, 1, 2, 3, or 4 (for each subsequent silane); and y represents a whole number, which is at least 2 and can be approximately infinite. The paste additionally includes a high-boiling organic solvent with a boiling point of 100° C. or above, and a pigment as the solvent, but does not include alcohol with a boiling point of below 100° C.

The present invention relates to a silkscreen paste, with which the printing also of glass used in cooking, frying, baking, and grilling appliances can be performed. This is in particular pre-stressed (but can also be not pre-stressed) Borofloat glass on borosilicate basis. The present invention further relates to a method for the production of this paste. Finally, the invention relates to the use of this paste for the production of possibly opaque silkscreen patterns on glass.

In household appliances, particularly in household ovens with a “pyrolytically self-cleaning” feature, any burned in cooking residues on the muffle walls may be pyrolyzed. The oven door of such a household oven is usually vitreous with multiple glass panes. During pyrolysis temperatures of up to 500° C. typically occur within the interior of the oven, and even the surface of the interior door glass facing the door interior is exposed to temperatures of up to 400° C., and possibly even up to 420° C. These temperatures that are substantially higher as opposed to the normal operating temperatures of a household oven demand the use of high quality glass for the vitrification of the oven door (for thermomechanical reasons). In this regard the use of borosilicate glass has prevailed. The glass typically used for such extraordinarily strongly temperature-stressed glass panes (windows) is therefore a Borofloat glass on the basis of borosilicate. This glass is thermally pre-stressed by heating to 650-800° C. and targeted cooling in order to additionally increase the stability of the glass in this manner, i.e. in order to make the glass more resistant to impact loads during use.

For design reasons, but also in order to achieve various functionalities of the household appliance, printing pastes are applied on the borosilicate glass by means of silkscreen or pad printing processes, and thermally hardened, or burned-in, respectively. The same applies to other glass (e.g. soda lime glass, or sodium/potassium silicate glass), which, however, has a lower quality compared to borosilicate glass with regard to mechanical stability and temperature stress.

Printing pastes on organic basis are resistant only up to about 300° C. due to their polymer matrix. At higher temperatures an oxidative decomposition of the binding agents begins to form, which leads to the optical and also the mechanical destruction of the print. Due to the thermal load of the glass windows in ovens mentioned above (temperatures of 400-420° C.) common organic printing pastes for the opaque covering of translucent panes in/on household appliances are eliminated.

Although in contrast to this, classical enamel patterns on inorganic basis would have sufficient thermal stability, they require temperatures of partially more than 500 for the burning-in process, however, in order to enable the glass flow of the frit. At these kinds of temperatures, however, substantial pre-stressing losses of the glass can occur. At the same time the aggressive glass frit microcracks inherent in manufacturing are enlarged, which are located in the glass surface. Both lead to a dramatic loss of stability of the pre-stressed Borofloat glass on one hand, and increase the risk of the glass breaking at the temperatures usually present in pyrolysis ovens, or with impact forces, on the other hand. Furthermore, such classical enamel patterns provide an insufficient bond to the surface of the Borofloat glass.

The burning-in temperatures of classical enamel patterns according to prior art can be reduced slightly, although not to temperatures below 500° C., by means of adding heavy metals. Therefore enamels for burning-in at between 500 and 600° C. also commonly contain PbO, Bi₂O₃, or similar. However, the use of heavy metals is not at all desirable for users in the area of household, and specifically kitchen appliances, such as ovens. The same applies to organic compounds that either volatilize or decompose at operating temperatures.

DE-A 42 17 432 describes a method for the production of glass with improved long-term stability at increased temperatures. In this method a composition being the product of a hydrolysis and condensation of at least one Si-compound in fluid phase, or of a respective pre-condensate, is applied to the glass by means of immersion, drawing, or spraying. By means of a subsequent thermal treatment a not completely condensed coat of a thickness of only 0.8 to 8 μm is formed. However, the coat is transparent, since it does not contain any microscale fillers, such as pigments. The composition, which is applied by means of immersion, drawing, or spraying onto the glass, contains (before the compression process) a large amount of alcohols that are formed during the course of the condensation process, and which are not removed. The coats achieved require high compression temperatures that are not suited particularly for pre-stressed glass.

A comparable, vitreous coat is described in DE-A 43 38 360, according to which the same is produced by mixing a composition obtained by hydrolysis and polycondensation of at least one hydrolysable silane SiX₄ (or an oligomer derived from it), and at least one organosilane with at least one hydrolysable, and possibly a non-hydrolysable radical (or an oligomer derived from the same), with at least one functional carrier, such as temperature resistant dye/pigment, metal/non-metallic oxide, coloring metallic ion, metal or metal compound colloid, and metallic ions that react under reduction conditions to metal colloids, the composition mixed with the function carrier is applied onto a substrate, and the coat obtained is thermally compressed. This coat is also applied by means of immersion or drawing, and remains transparent. The layer thicknesses described are a few μm (1-3.5 μm). The base sol was produced in ethanol as the solvent. During the course of the polycondensation, additional ethanol was formed, before ethanol was again added while forming a coat solution that is suitable for storage.

Thicker, but still transparent coats are described in DE-A 100 18 697. Nanoparticles are first organically bound, before the organic binder is thermally added. A lose bond of nanoparticles is created, which are subsequently sintered at temperatures within a range of 450-1200° C. in order to achieve mechanically stable layers. The coats obtained are used in optics, optoelectronics, or in electronics. According to the task of producing a transparent coat, pigments are not used, or used only as traces (as a doping agent).

Another coat on the basis of silanes with hydrolysable radicals similar to the coat described in DE-A 43 38 360, which is also applied by means of silkscreen process, is described in DE-A 198 16 136. The sol obtained from condensation is an aqueous, an alcoholic, or an aqueous/alcoholic sol. After the condensation, during which the alcohols are formed, these are largely removed and replaced with water in order to adjust the suitable viscosity of the resulting composition in this manner. This possibility of adjusting the viscosity presumes that after the removal of the alcohol released due to hydrolysis and condensation, the system is still in an aqueous aggregate state. This is generally possible only if the condensation is stopped at relatively low condensation levels (<50%). However, in the case of the present coat, this can be achieved only if the silane used contains at least one cross-linkable organic radical. This radical blocks the condensation effectively in a twofold sense. On one hand it blocks a cross-linking location, on the other hand it also prevents the polycondensation of the siliceous network to a substantial extent for steric reasons. Therefore, none of the examples of DE-A 198 16 136 describes a method in which a silane is used without any cross-linkable organic radical. Instead, GLYEO (y-glycidloxy propyl triethoxysilane) is regularly used. Therefore it also does not come as a surprise that after the removal of the alcohol released during the alcoholysis and the polycondensation, such systems do not gel, i.e. that they remain in an aqueous state. Silanes with at least one cross-linkable organic radical, however, cannot be used for temperature stable decorations in the area of a range, because they are not sufficiently thermally stable, which would lead to substantial emissions during operation, up to the destruction of the decor.

A printing paste that can be burned-in for the printing of glass at 500-700° C. is known from DE-C 44 07 366. The paste contains a low-melting glass component, i.e. heavy metal and/or alkali/earth alkali metallic oxides, as well as high-melting pigments. The oxides lowering the melting point of the glass component are just as undesirable as the high burning-in temperature due to the loss of solidity of the glass.

Another printing paste that can be burned-in for the printing of glass is known from DE-A 195 25 658. This paste also contains a low-melting glass component, i.e. heavy metal and/or alkali/earth alkali metallic oxides, as well as inorganic (=high-melting) pigments. The latter require burning-in temperatures of at least 500° C.

DE-C 100 07 923 describes a respective imprint on the door surface (this is the surface subjected to impact during the use of the oven) facing the oven (the baking muffle). However, the known glass flows for borosilicate glass contain a lot of lead, and the lead is slowly released from the surface of the coating during the strong heating (in a temperature range occurring during pyrolysis of significantly over 400° C.) and reaches the oven area. In extreme cases, this may cause health risks to the user. Furthermore, a coating of the known type has a rough surface with only a limited esthetically pleasing impression.

Another manner in which to imprint glass panes of ovens is contained in DE-A 198 14 211. The claimed method comprises the steps of applying a liquid mixture with a dye that is dissolved in at least one solvent, and a hardener, and subsequently drying the mixture under evaporation of the at least one solvent at less than 200° C., and to harden the chemical cross-linking between the dye and the hardener. A transparent varnish with a low thickness is obtained. The chemical composition of the individual components of the liquid mixture is not further characterized. This patent document merely mentions a special glass paint made by Marabuwerke GmbH & Co. in Tamm (Germany). However, it is a paint on organic basis, e.g. on the basis of epoxy resins, which at 140° C. already can be stressed for half an hour at the longest.

EP-A 0 535 474 illustrates a method for the production of a single or double curved laminated glass pane, in particular for motor vehicles. In the method described “classical” silkscreen enamel is used, i.e. glass frits are used in the silkscreen material. The silanes are merely used as additives, the function of which exists in the fusing of the decor prints after drying (these silanes only have a low temperature function; they have the advantage of being effective at a low temperature without thermally decomposing at a higher temperature. This means that the silanes do not form a vitreous matrix after the thermal compression of the application mass, or that a matrix formed is not sufficient for the employing of the glass frits.

The inventors have therefore made it their task to provide a material, more precisely a paste suitable for the silkscreen process, with a good storage stability, which is suitable for opaquely imprinting glass (panes), in particular pre-stressed borosilicate glass (panes). Due to the requirement of being suitable for the silkscreen process, an additional requirement is demanded of the paste: it must have a sufficiently long life in the screen. The printed borosilicate glass must have a mechanical stability that is sufficiently well enough in order to ensure an error-free operation in, for example, an oven, further must not contain any physiologically precarious heavy metals, or their oxides, respectively, and also must not release any harmful emissions (e.g. in the form of decomposition products) even during the operation at temperatures of up to 400 or 420° C., but should certainly be thermally resistant at these temperatures. The material should be able to be combined with glass, in particular borosilicate glass, and able to be processed at burning-in temperatures, which do not adversely affect the thermal pre-stressing of the glass to be imprinted. Preferably, these temperatures are below 300° C., more exactly at 200 to below 300° C., preferably at 250-280° C. As long as the pre-stressing is not affected, or the adverse effect of the pre-stressing has no negative effect depending on the use of the imprinted glass, the burning-in temperatures may also be above 300° C. The prints should also have an adequate acutance and scratch resistance, a sufficiently large optical density (opaque), and a good adhesion to the glass, and all this, of course, at the operating temperatures of up to 420° C.

The inventors have solved this task in that they have provided a paste suitable for the silkscreen process, which is free of enamel. Accordingly, the present invention according to a first aspect relates to a paste according to claim 1. Another aspect of the present invention relates to a method for the production of this paste according to claim 10. Finally, a silkscreen process for the application of decorative prints using this paste represents a last aspect of the present invention.

According to the invention, “enamel” is defined as a glass frit without any pigments (as opposed to the usual definition, according to which enamel is the combination of glass frit and pigment). According to the invention, only the glass frit is omitted, but not the pigment, which is what is meant by the term “free of enamel”, or “enamel-free.”

The inventors have succeeded in developing sol compositions that are capable of partially or completely taking on the functions ((i) adjustment of a optimal rheology of the silkscreen paste in as much as possible; (ii) increase of the life in the screen; (iii) fusion of the print before the burning-in step) of common silkscreen oils (in particular high-boiling organic solvents). Function (iii) is ensured at a given sol composition by means of the polycondensation of a mixture of at least one silane of general formula RₓSi(OR′)₄₋ₓ (wherein: R represents alkyl, aryl, arylakyl, alkylaryl or H; R′ represents H, methyl, ethyl, n- or i-propyl, n-, iso-, sec-, or tert-butyl; x (for the first silane) represents 0 or 1; x (for each subsequent silane) represents 0, 1, 2, 3, or 4), and at least one polysiloxane of general formula [R₂SiO]_{y}, (more exact: R₃Si—(O—SiR₂)_{y}—O—SiR₃; wherein: R in turn represents alkyl, aryl, arylalkyl, alkylaryl, or H, and y represents a whole number which is at least 2 and can be approximately infinite). The at least one polysiloxane is also known as silicate thinner component, or silicate reactive thinner. This silicate reactive thinner (alone, without silane) is responsible for increasing the life in the screen. It is also integral part of the binder matrix of the paste and enables, particularly in the silkscreen process, the performance of the steps of drying and burning-in without releasing or decomposing larger amounts of solvent, which makes it possible to perform these two steps in a more environmentally friendly manner. The reactive thinner further contributes to a good cross-linking of the glass during the printing process due to its reduced surface tension, which leads to a high acutance, and an excellent adhesion to the substrate surface. The combination of the organosilanes with the silicate reactive thinners finally ensures that the properties of the decoration after the burning-in are comparable to those of decorations on the basis of polymers.

Finally, the rheology (function (i)) is influenced on one hand by the product of hydrolysis and condensation of the at least one silane of general formula RₓSi(OR′)₄₋ₓ with the at least one polysiloxane of general formula [R₂SiO]_{y}, or R₃Si—(O—SiR₂)_{y}—OSiR₃, respectively. On the other hand, finely dispersed nanoparticles, especially SiO₂ and Al₂O₃, which, however, are not an essential part of the silkscreen process according to the invention, also contribute to their rheology (additionally the nanoparticles achieve larger layer thicknesses due to their intermolecular interactions, which can be a decisive factor with regard to the opaque property).

Preferably, x is defined as 1 for the first silane.

According to another preferred embodiment of the paste according to the invention, R′ represents either h, methyl, or ethyl.

An essential advantage of the paste according to the invention is that the decorations that can be obtained with it do not release any crack products, and are also not decomposed. Instead, after thermal stressing a decoration is the result, which in its properties is comparable to a classical enamel decoration, but additionally has an excellent adhesion to the surface of the Borofloat glass.

The printing paste according to the invention, which is free of any enamel (according to above definition), contains a matrix on the basis of a Si-polymer, which can be obtained by means of hydrolysis and condensation, preferably initiated by means of a catalyst, of at least one silane of general formula RₓSi(OR′)₄₋ₓ with at least one polysiloxane of general formula [R₂SiO]_{y}, or R₃Si—(O—SiR₂)_{y}—O—SiR₃, respectively, wherein:
the radicals R can independently be alkyl, aryl, arylalkyl, alkylaryl or H;
the radicals R′ can independently be H, methyl, ethyl, n- or i-propyl, n-, iso-, sec- or tert-butyl;
x represents 0 or 1 (for the first silane);
x represents 0, 1, 2, 3, or 4 (for each subsequent silane); and
y represents a whole number, which is at least 2 and can be approximately infinite.

Alcohols or water, respectively, are formed during the condensation, which are largely removed again during the course of production, and are replaced with a high-boiling solvent. The printing paste according to the invention is therefore comprised of at least one high-boiling organic solvent. According to the invention, a high-boiling organic solvent is defined as a solvent with a boiling point of 100° C. or above. Preferred high-boiling organic solvents are α-pinene, n-butyl acetate, 2-butanol, isopropoxy-ethanol, butyl glycol, and terpineol.

The term “high-boiling organic solvent” however, neither comprises water (inorganic) nor alcohols with a boiling point of below 100° C., such as methanol or ethanol at any appreciably quantity (although traces of byproducts of the condensation=water, or alcohols, respectively, with a boiling point of below 100° C. will always be present in practice, but cannot be called solvents at these low quantities, and are contained at a total of less than 5%, preferably less than 3% based on the total mass of the finished printing paste.

Another component of the printing paste according to the invention is a pigment. Temperature resistant, organic, preferably nontoxic pigments, or pigments causing no toxic emissions are commonly used for coloring, such as are also used in enamel paints. Especially preferred pigments in the sense of the invention are graphite, TiO₂, or a mixture of both. Another advantage of the invention is that graphite can also be used as the pigment. This is not possible with many of the enamel paints, because graphite is oxidatively affected during the burning-in.

The paste according to the invention can further be comprised of dispersed nanoparticles, preferably in the form of the oxides of Si and Al. the paste can further be comprised of additives, specifically thickeners and thixotroping agents.

The method for the production of the printing paste according to the invention is described in the following. This method is comprised of the steps of
(a) converting at least one silane of general formula RₓSi(OR′)₄₋ₓ via hydrolysis and condensation with at least one polysiloxane of general formula [R₂SiO]_{y}, or R₃Si—(O—SiR₂)_{y}—O—SiR₃, respectively, wherein: R, R′, x, and y are defined as outlined in claim 1;
(b) adding at least one pigment (i.e. hydrolysis and condensation may proceed in the presence of the pigment, but the pigment can also be added afterwards) to the mixture in, or of step (a);
(c) adding a high-boiling organic solvent with a boiling point of at least 100° C. to the mixture of step (a), or (b), respectively;
(d) removing the water/alcohol formed during hydrolysis and condensation from the mixture obtained in step (c).

According to a preferred embodiment the one silane is at least methyl triethoxysilane and tetraethoxysilane, particularly at a ratio of 3-4:1, especially 3.4:1 (if not stated otherwise, the quantities/concentrations stated in this description and in the claims relate to the mass).

According to another preferred embodiment hydrolysis and condensation occur in step (a) in the presence of a thickener, or thixotroping agent, respectively. As an alternative, the thickener, or the thixotroping agent, respectively, are added after the hydrolysis and condensation of step (a). Preferably the thickener, or the thixotroping agent, respectively, for the control of rheology is a PVA, a PEG, or a cellulose derivative, such as methyl or ethyl cellulose.

According to a third preferred embodiment the hydrolysis and condensation in step (a) occur in the presence of a catalyst, which is in particular a diluted mineral acid, particularly sulfuric acid, especially 37.5% sulfuric acid, which is commercially available under the name accumulator acid. The finished paste therefore preferably contains low quantities (up to 3$) of this type of catalyst.

According to a fourth preferred embodiment the hydrolysis and condensation in step (a) occur in the presence of a finely dispersed filler. As an alternative the finely dispersed filler is added after the hydrolysis and condensation of step (a). Preferably the finely dispersed filler is nanoscale SiO₂, or Al₂O₃, particularly silica sol, such as Levasil® 50/50.

According to a fifth preferred embodiment the removal of the water/alcohol formed in step (a) occurs by means of distillation or by means of precipitation of the binder phase formed in step (a).

According to a sixth preferred embodiment step (c) occurs before step (d).

According to a seventh preferred embodiment the individual components, based on the total mass of the finished paste, are present at the following ratios: silane 30 to 84%, preferably 40 to 65%, polysiloxane 0.1 to 40%, preferably 2.5 to 15%; pigments 5 to 40%, preferably 7 to 12%; high-boiling solvent 10 to 50%, preferably 30 to 45%; finely dispersed filler (=dispersed nanoparticles) 0 to 20%, preferably 50 to 10%; binder (thickener)/thixotroping agent 0 to 10%, preferably 2 to 7%, and catalyst for the condensation 0 to 3%, preferably 0.5 to 2%.

As a consequence, preferred embodiments of the printing paste are also the result from the previous mass-related information of the individual components based on the method for the production of the paste.

Properties/processing of the Paste

Surprisingly it was found that the matrix (on the basis of a Si-polymer) of the paste according to the present invention is already produced at burning-in (“burned out”) temperatures of less than 300° C. to the extent that no additional harmful decomposition products are developed for the user during the operation at temperatures of up to 420° C. The relatively low burning-in temperature prevents the thermal expansion of the glass. Higher burning-in temperatures may also be set as long as they do not adversely affect the thermal pre-stressing of the glass to be imprinted, or as long as a adversely affecting pre-stressing has no negative effects depending on the use of the imprinted glass. The printing paste does not melt during burning-in—pure SiO₂ only softens at above 1100° C. —, but instead compresses across chemical reactions.

The imprinting of the oven door with the paste according to the invention is—in a basically known manner—preferably embodied by means of a silkscreen process according to the ergonomic or artistic guidelines, wherein for example a 77T or 100T silkscreen web may be employed. Preferably the surface of the glass equipped with the imprint is cleaned before the printing with an organic solvent (especially with acetone, or a low alcohol, such as methanol, ethanol, or I-propanol). If necessary, an agent further improving the adhesion on the glass surface at a maximum quantity of 0.2% (based on the mass of the paste), such as a polysiloxane, a polyethersiloxane copolymer, or a Ti-alcoholate is added to the paste.

According to the invention the paste according to one of the claims 1 to 9 is applied to the glass, particularly to borosilicate glass with the silkscreen process for the application of decorative prints onto glass to be thermally stressed, and together with the glass subjected to the thermal burning-in at a temperature of preferably below 300° C. Especially preferred burning-in temperatures for the compression of the decoration are at 250-280° C.

According to a preferred embodiment of the silkscreen process according to the invention, the step of burning-in is preceded by a drying step at 150 to 180° C., preferably at about 170° C. Not only can the substances be at least partially removed from the decoration with this pre-drying (this is mainly the high-boiling organic solvent, as well as possibly the thickener, or the thixotroping agent, respectively), which would be responsible for harmful emissions during the operation of the oven. In fact the glasses can be handled and stored well before the burning-in due to the drying process, since the paste is dried, and adheres better to the glass.

### EXAMPLES

### Example 1

Production of the Printing Paste According to the Invention

The base material of the silkscreen paste was produced from methyl triethoxysilane and tetraethoxysilane at a ratio of 3.4:1 (81% total). 18% of a silica sol (e.g. Levasil® 50/50) was added to this mixture. The hydrolysis and condensation were initiated by means of adding 1% of 37.% sulfuric acid. Based on this mixture (consisting of silane, silica sol, and sulfuric acid; 100% total), 6% of diethoxy/polydimethylsiloxane were added as a polysiloxane. The alcohol released during hydrolysis and condensation was removed from the reaction mixture by means of distillation, and exchanged with butyl acetate. The mass of butyl acetate added was 50%, again based on the mass of 100% of silane, silica sol, and acid.

A low viscous, milky liquid was obtained, which was added to ethyl cellulose (4%, based on the total paste=100%) and to a second aliquot of a high-boiling solvent (this time terpineol, 18%, also based on the total paste=100%) for the production of a silkscreen paste. The pigment coating occurred with the adding of graphite (8%, also based on the total paste=100%).

### Example 2

Use of the Printing Paste for the Silkscreen Produced in Example 1

The silkscreen paste of example 1 was processed with a common silkscreen stock using a polyester web (e.g. 325 mesh) and a silicone coating knife into decorations made of borosilicate glass. After a brief pre-drying period at 170° C., which served for the removal of the silkscreen printing additive (solvent and ethyl cellulose) from the decoration, the decoration was compressed over a time period of 10 min at 270° C. A dark-gray colored, very well adhering, and largely emission-free decoration was obtained, which was stable at temperatures of up to 650° C. with a good consistent adhesion to the substrate.

1-20. (canceled)

21. An enamel-free paste with a matrix based upon a Si-polymer that can be obtained by the hydrolysis and condensation of at least one silane of a general formula RₓSi(OR′)₄₋ₓ with at least one polysiloxane of general formula [R₂SiO]_{y}, or R₃Si—(O—SiR₂)_{y}—O—SiR₃, respectively, wherein:
said radicals R can independently be alkyl, aryl,arylalkyl, alkylaryl or H;
said radicals R′ can independently be H, methyl, ethyl, n- or i-propyl, n-, iso-, sec- or tert-butyl;
x represents 0 or 1 (for the first silane);
x represents 0, 1, 2, 3, or 4 (for each subsequent silane); and
y represents a whole number, which is at least 2 and can be approximately infinite;
wherein said paste additionally includes a high-boiling organic solvent with a boiling point of 100° C. or above, and a pigment as the solvent, but contains no alcohol with a boiling point of substantially below 100° C.

22. The paste according to claim 21, wherein x represents 1 for said first silane.

23. The paste according to claim 21, wherein the total content of said paste of water and alcohols with a boiling point of below 100° C., based on the total mass of said paste, is less than substantially about five (5) percent (%).

24. The paste according to claim 21, wherein said pigments are temperature resistant inorganic pigments.

25. The paste according to claim 21, wherein said temperature resistant inorganic pigments are graphite or TiO₂.

26. The paste according to claim 21, wherein said paste further includes dispersed nanoparticles, preferably in the form of at least one of the oxides of Si and Al, and a catalyst, which has initiated the hydrolysis and condensation of silane(s) and polysiloxane(s).

27. The paste according to claim 21, wherein said paste additionally includes at least one of a thickener and a thixotroping agent.

28. The paste according to claim 21, wherein R′ represents H, methyl, or ethyl.

29. The paste according to claim 21, wherein said at least one silane is methyl triethoxysilane and tetraethoxysilane.

30. A method for the production of an enamel-free paste with a matrix based upon a Si-polymer that can be obtained by the hydrolysis and condensation of at least one silane of a general formula RₓSi(OR′)₄₋ₓ with at least one polysiloxane of general formula [R₂SiO]_{y}, or R₃Si—(O—SiR₂)_{y}—O—SiR₃, respectively, including
said radicals R can independently be alkyl, aryl,arylalkyl, alkylaryl or H;
said radicals R′ can independently be H, methyl,ethyl, n- or i-propyl, n-, iso-, sec- or tert-butyl;
x represents 0 or 1 (for the first silane);
x represents 0, 1, 2, 3, or 4 (for each subsequent silane); and
y represents a whole number, which is at least 2 and can be approximately infinite;
wherein said paste additionally includes a high-boiling organic solvent with a boiling point of 100° C. or above, and a pigment as the solvent, but contains no alcohol with a boiling point of substantially below 100° C.;
said method comprising the steps of:
(a) converting at least one silane of a general formula RₓSi(OR′)₄₋ₓ via hydrolysis and condensation with at least one polysiloxane of a general formula at least one of [R₂SiO]_{y} or R₃Si—(O—SiR₂)_{y}—O—SiR₃, respectively;
(b) adding at least one pigment one of before, during or after step (a);
(c) adding a high-boiling organic solvent with a boiling point of at least 100° C. to the mixture of one of step (a), or step (b), respectively; and
(d) removing the water and/or alcohol formed during said hydrolysis and condensation from the mixture obtained in step (c).

31. The method according to claim 30, wherein said hydrolysis and condensation in step (a) occur in the presence of at least one of a thickener, or thixotroping agent, respectively.

32. The method according to claim 31, wherein said thickener, or said thixotroping agent, respectively, is added after said hydrolysis and condensation of step (a).

33. The method according to claim 30, wherein said hydrolysis and condensation in step (a) occur in the presence of a catalyst.

34. The method according to claim 30, wherein said hydrolysis and condensation in step (a) occur in the presence of a finely dispersed filler.

35. The method according to claim 34, wherein said finely dispersed filler is added after said hydrolysis and condensation of step (a).

36. The method according to claim 30, wherein said removal of said water/alcohol formed in step (a) occurs by at least one of means of distillation or by means of precipitation of the binder phase formed in step (a).

37. The method according to claim 30, wherein step (c) occurs before step (d).

38. A silkscreen process for the application of decorative prints on glass to be thermally stressed, comprising:
applying an enamel-free paste with a matrix based upon a Si-polymer that can be obtained by the hydrolysis and condensation of at least one silane of a general formula RₓSi(OR′)₄₋ₓ with at least one polysiloxane of general formula [R₂SiO]_{y}, or R₃Si—(O—SiR₂)_{y}—O—SiR₃, respectively, including
said radicals R can independently be alkyl, aryl,arylalkyl, alkylaryl or H;
said radicals R′ can independently be H, methyl, ethyl, n- or i-propyl, n-, iso-, sec- or tert-butyl;
x represents 0 or 1 (for the first silane);
x represents 0, 1, 2, 3, or 4 (for each subsequent silane); and
y represents a whole number, which is at least 2 and can be approximately infinite;
wherein said paste additionally includes a high-boiling organic solvent with a boiling point of 100° C. or above, and a pigment as the solvent, but contains no alcohol with a boiling point of substantially below 100° C. onto the glass to be decorated; and
subjecting said paste and said glass to a thermal burning-in.

39. The method according to claim 38, wherein said burning-in occurs substantially at about 250-280° C.

40. The method according to claim 38, wherein said-burning-in is preceded by a drying step substantially at about 150 to 180° C. in order to remove at least said high-boiling organic solvent, as well as possibly said thickener, or said thixotroping agent.
